(19) United States
(12) Patent Application Publication
(10) Pub. No.: US 2003/0047095 A1
(43) Pub. Date: Mar. 13, 2003

(54) Multi- functional stamping device

(76) Inventor: Young Kook Cho, Vernon, CA (US)

Correspondence Address: Jerry H. Noh, Suite 1110, 3350 Wilshire Blvd., Los Angeles, CA, 90010, US

(21) Appl. No.: 10/052,833

(22) Filed: Jan. 17, 2002

(30) Foreign Application Priority Data
Sep. 8, 2001 (KR) 2001-55299

(51) Int. Cl. B41K 1/38; B41F 31/00

(52) U.S. Cl. 101/327; 101/333

(57) ABSTRACT

A multi-functional stamping device comprising a housing having a stamp outcome port and a plurality of stamp members provided in the housing. Each stamp member having a predetermined image imprinted on a print pad with ink supplied by an ink cartridge attached thereto. The device further having a means for lowering a selected one of the stamp members, externally releasing the lower portion of the selected stamp member out of the housing through the stamp outcome port, and retracting the extracted stamp member back into the housing. The device also includes a cover system for opening the stamp outcome port when the selected stamp member is being extracted and automatically closing the stamp outcome port when the selected stamp member is being retracted into the housing.

### BACKGROUND OF THE INVENTION

The invention relates to a stamping device. More specifically, the present invention relates to a multi-functional stamping device that enables a user to make a selective stamping from a variety of stamp templates prepared therein.

In general, a stamp consists of a print pad (also may be referred to as stamp pad) device having a preformed mark thereon. The pad device either has a handle affixed thereto or is housed in a container. The stamp is pressed on a red, green or blue ink pad and used to for inking on documents the mark preformed thereon that is in frequent use. Other stamps which are housed in a container have an ink pad formed inside the container so that the stamp pad is pressed automatically on the ink pad each time prior to exiting the container for use. Various stamps are put in use, for example, to place numerals on price tags or to place a predetermined sign on documents. Each stamp is manufactured for its specific utility. For multiple stamp needs, it has been inconvenient to properly store various stamps and locate the desired specific stamp when needed.

As usually witnessed in an office environment, various stamps are stored in different locations, and a person desiring to use a particular stamp would have to spend time locating the proper stamp. Most conventional stamp devices need to be accompanied by a separate ink pad, and extra care is required for storing ink pads as well as stamps.

### SUMMARY OF THE INVENTION

The invention is contrived to overcome the conventional disadvantages. Therefore, an objective of the present invention is to provide a multi-functional stamping device that allows multiple preformed stamp pads to be stored in one container. Furthermore, it is another objective of the present invention to provide a multi-functional stamping device in which the stamp pads have a self-inking capability to eliminate the need for a separate ink pad. It is a further objective of the present invention to provide a multi-functional stamping device in which only a single needed stamp comes out from the container at one time and a counting means provided thereon keeps count of the times a particular stamp is used. Another objective of the present invention is to prevent contamination during stamp storage by preventing the ink on the stamp from contacting other substances.

To achieve the above-described objects, the multi-functional stamping device according to the present invention comprises a housing having a stamp outcome port and a plurality of stamp members provided in the housing. The stamp members each have an ink cartridge providing a continuous ink supply to a print pad. Each print pad has a predetermined image thereon for inking the image onto a desired surface. The device further includes a means for lowering a selected one of the stamp members, externally releasing the lower portion of the selected stamp member out of the housing through the stamp outcome port, and retracting the extracted stamp member back into the housing. Also, the device of the present invention comprises a cover system for opening the stamp outcome port when the selected stamp member is being extracted, and automatically closing the stamp outcome port when the selected stamp member is being retracted into the housing.

Although the present invention is briefly summarized, the fuller understanding of the invention can be obtained by the following drawings, detailed description and appended claims.

### BRIEF DESCIPTION OF THE DRAWINGS

These and other features, aspects and advantages of the present invention will become better understood with reference to the accompanying drawings, wherein:

FIG. 1 is a perspective view showing a multi-functional stamping device according to the present invention;

FIG. 2 is a cross-sectional view of the stamping device in FIG. 1 cut along the 2-2 line;

FIG. 3 is a cross-sectional view of the stamping device shown with one of the stamping members in the extracted position;

FIG. 4 is a view taken from the 4-4 line of FIG. 2;

FIG. 5 is a cross-sectional view of a second embodiment of the stamping device showing a partial enlargement view of the cover system at the lower portion of the housing;

FIG. 6 is a top plan view of the present invention;

FIG. 7 is an enlarged cross-sectional view of a portion of the lower end of the housing and a stamp member of the present invention;

FIG. 8 is a cross-sectional view of a third embodiment of the stamping device showing a partial enlargement view of the cover system at the lower portion of the housing;

FIG. 9 is a partial cross-sectional view of a fourth embodiment of the present invention; and,

FIG. 10 is an isolated view of a multiple stamp member according to the fourth embodiment of the present invention.

### DETAILED DESCRIPTION OF THE PREFERRED EMBODIMENTS

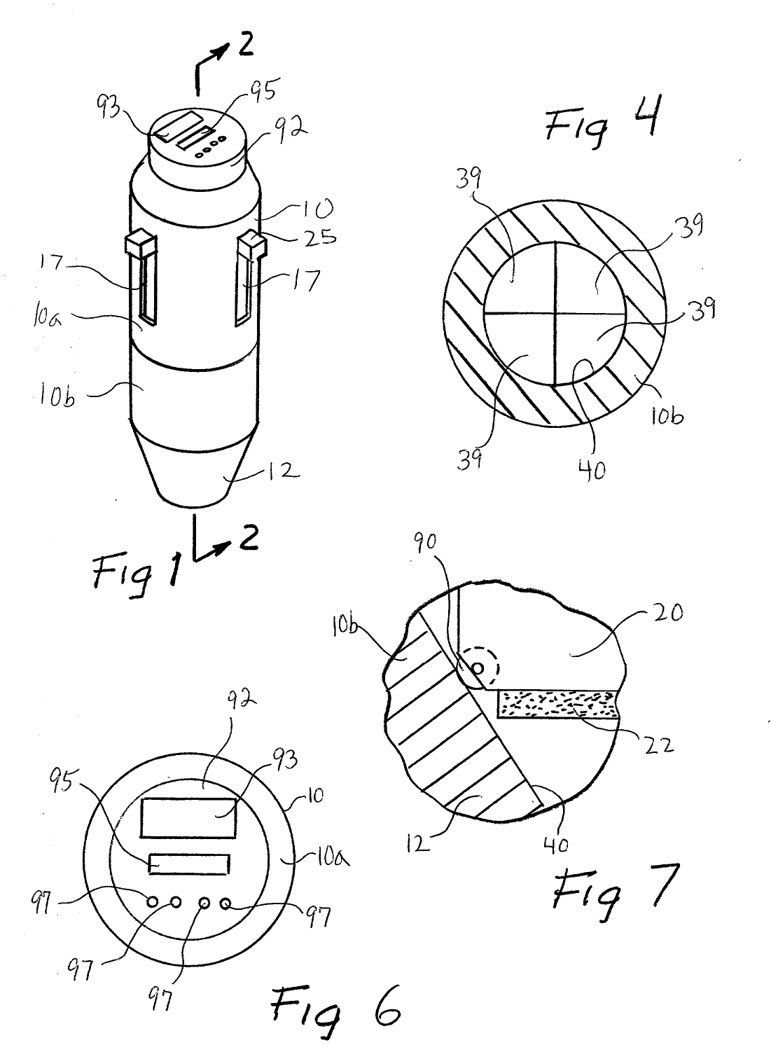

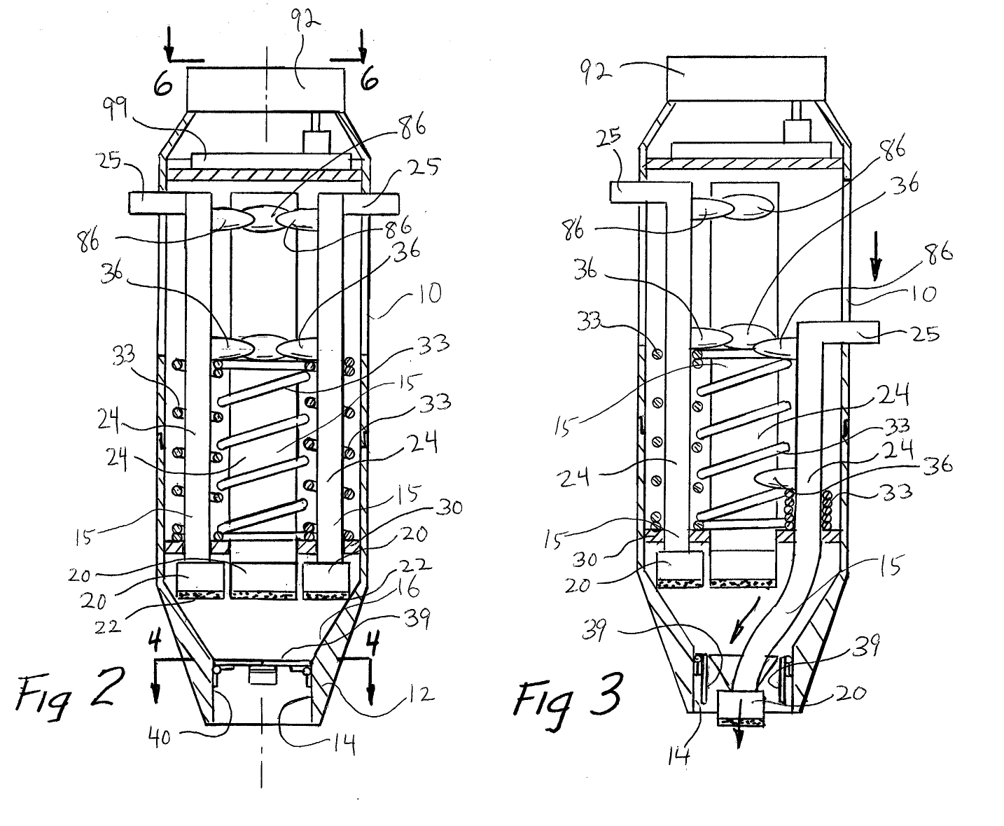

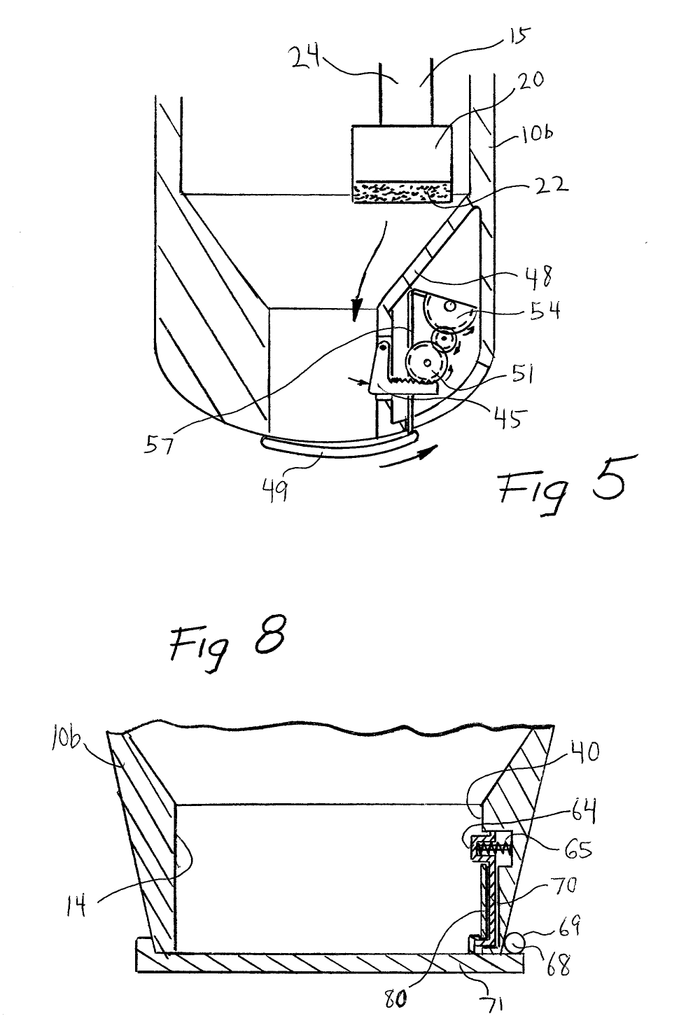

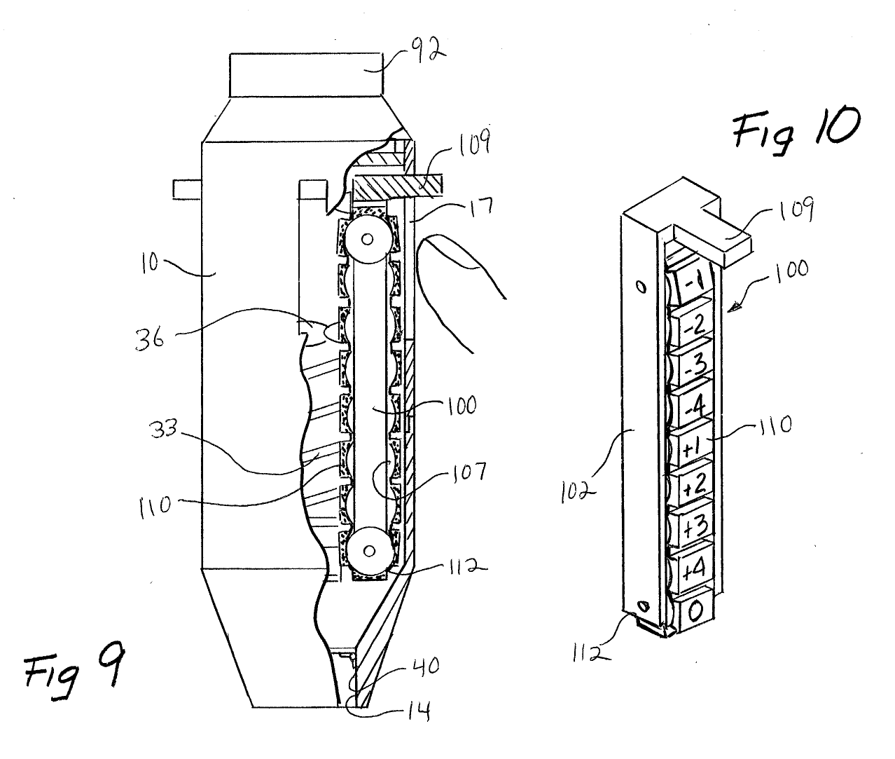

With reference to the accompanying drawings, the multi-functional stamping device will now be described. As shown in FIGS. 1 and 2, the multi-functional stamping device according to the present invention includes a housing 10 and a plurality of stamp members 15 provided therein. As an illustration of an embodiment of the present invention, a stamping device with four stamp members 15 mounted therein will be explained.

The housing 10 is incorporated in cylindrical upper housing portion 10a and lower housing portion 10b which are detachably engaged to each other. The plurality of stamp members 15 are provided inside the upper and lower housing portions 10a, 10b. The stamp members further comprise a stamp cartridge 20 connecting to a print pad 22 and a lift rod 24 having a handle portion 25. A plurality of vertically elongate openings17 are formed along the outer periphery of the upper housing 10a to receive therein the handle portion 25 of the lift rods 24. A stamp outcome port 14 is formed through a lower end 12 of the lower housing portion 10b.

The lower end 12 of the lower housing portion 10b is tapered toward the stamp outcome port 14. Inside the lower end 12 of the lower housing portion 10b is formed a downward slope 16 on which is either applied an alloy film with a low friction coefficient or installed a roller bearing. Although the housing 10 is formed in a cylindrical shape in the illustrated embodiment of the present invention, it may be also formed in prisms such as a quadratic prism.

The stamp cartridges 20 contain ink absorbents, specifically, an ink absorbent made of porous rubber or felt. On the lower part of each stamp cartridge 20 is attached the print pad 22 that may be either impressed or embossed with a predetermined image thereon such as numbers, letters, or characters. The print pad 22 can be made of hard or dense rubber. In this construction, the ink absorbents containing ink can continuously feed the print pads 22 with ink. The predetermined image on the print pad 22 can be used for imprinting the inked image onto an external object thereon. One of the print pads 22 of the stamp member 15 may be an ink removing stamp that absorbs the ink on the external stamped object.

The handle portion 25 is manually moveable to control the movement of a corresponding stamp member between a retracted position wherein the stamp member 15 is positioned within the housing 10 and an extracted position wherein the stamp member 15 protrudes outside the stamp outcome port 14 of housing 10. FIG. 2 shows all of the stamp members 15 being in the retracted position, and FIG. 3 shows one stamp member 15 moving to the extracted position. Each stamp member 15 is biased to remain in the retracted position with the use of a fixed plate 30 affixed within the housing 10, springs 33, and a first protrusion 36 formed toward the upper end of each lift rod 24. The fixed plate 30 supports each lift rod 24 of a stamp member 15, and each spring 33 is located around each lift rod 24 between the first protrusion 36 and fixed plate 30. Each spring 33 is biased to urge each corresponding stamp member 15 towards the retracted position.

The housing 10 further includes a cover system for covering and opening the stamp outcome port 14. The cover system ensures that the stamp outcome port 14 is covered when all stamp members 15 are in the retracted position to prevent ink evaporation from the print pads 22. Also, the covering system also serves to protect the print pads 22 from pollution by dirt or other alienate matters. Different cover systems may be known in the prior art; however, three different cover systems which work well with the multiple stamping device of the present invention will be discussed.

The first cover system comprises one or more lids 39 hingeably attached to an inner wall surface 40 of the stamp outcome port 14. The lids are formed in a manner to collectively cover the stamp outcome port 14 when placed in a closed position as shown in FIGS. 2 and 4. FIGS. 2-4 show a housing 10 having four lids 39. Each lid 39 has a coiled return spring 42 hingeably connecting the lid 39 to inner wall surface 40 of the stamp outcome port 14, and each lid 39 is biased to move towards the closed position. When a selected stamp member 15 is lowered, the stamp member 15 urges the one or more lids 39 away from the stamp outcome port 14 as the stamp member 15 moves through the stamp outcome port 14 to the extracted position as shown in FIG. 3. When a stamp member 15 moves from an extracted position to the retracted position, the movement of the stamp member 15 back into the housing 10 allows the one or more lids 39 to return to the closed position.

An alternative second cover system as shown in FIG. 5 comprises a push button switch 45 protruding from the inner wall 48 of the lower housing portion 10b adjacent and above the stamp outcome port 14. The switch 45 is biased to protrude from the inner wall 48. A door 49 is slideably mounted adjacent the stamp outcome port 14 of the lower housing portion 10b, and the door 49 slides to cover and uncover the stamp outcome port 14. A gear assembly is contained within the inner wall 48 adjacent the stamp outcome port 14, and the gear assembly has a first gear member 51 engaging the switch 45 and a second gear 54 connecting to a pin 57. The pin 57 connects to the door 49. When a selected stamp member 15 is lowered, the stamp member 15 pushes the switch 45 into the inner wall 48 urging the gear assembly to slide the door 49 away from the stamp outcome port 14 and allowing the stamp member 15 to exit through the uncovered stamp outcome port 14 to the extracted position, When a stamp member moves from an extracted position to the retracted position, the movement of said stamp member into the housing allows the switch member 45 to protrude from the inner wall 48 which allows the gear assembly to return the door 49 to a position covering the stamp outcome port 14. A return spring (not shown) in the gear assembly is positioned to urge the switch 45 to protrude from the inner wall 48.

An alternative third embodiment of the cover system is shown in FIG. 3 in which the cover system comprises a push button 64 formed protruding from the inner wall surface 40 of the stamp outcome port 14 and elastically supported by a coil spring 65 at an upper portion of the inner wall surface 40 of the stamp outcome port 14. A hinge 68 hooked by a return spring 69 is elastically supported in a lower portion of the lower housing portion 10b. A lid 71 is also formed to cover the stamp outcome port 14. A first hook 70 is engaged to the push button 64 to open the lid 71 when the push button 64 is pushed. A second hook 80 mutually hooked with the first hook 70 is formed adjacent to the lid 71. Accordingly, when the lid 71 is closed, the first and second hooks 70, 80 are hooked to each other, and when a stamp member 15 being lowered pushes the push button 64, the first hook 70 is retreated in accordance therewith and at the same time unhooked from the second hook 80, whereby the lid 71 becomes opened by the elasticity of the return spring 69.

For stamping, each stamp member 15 in the housing 10 can come out of the housing 10 through the stamp outcome port 14 and remain in the extracted position so that the print pad 22 embossed or impressed with an image thereon can ink that image onto the desired surface. When a stamp member 15 is lowered to the retracted position, it remains in that position through the use of a second protrusion 86 placed a predetermined distance above the first protrusion 36 on each lift rod 24. When the selected lift rod 24 is being lowered, its second protrusion 86 becomes hooked by the first protrusion 36 of the adjacent lift rod 24 so the selected lift rod 24 is prevented from being lifted by the adjacent lift rod 24 and at the same time the adjacent lift rod 24 is also prevented from being lowered by the selected lift rod 24. When the adjacent lift rod 24 is being lowered, the second protrusion 86 of the selected lift rod 24 becomes released from the first protrusion 36 of the adjacent lift rod 24 and elastically lifted by the elastic return force of the coiled spring 33.

When the use of the stamp member 15 is completed, the adjacent lift rod 24 is lowered to a slight extent in order to retract the extracted and used stamp member 15. That is, the second protrusion 86 of the lowered and used stamp member 15 becomes unhooked from the first protrusion 36 of the adjacent lift rod 24 and accordingly the elastically suppressed lift rod 24 attached to the extracted and used stamp member 15 promptly becomes lifted in accordance with the elasticity of the coil spring 33.

FIG. 7 is an enlarged view of a partial portion of the lower end of the lower housing portion 10b of FIG. 2 with a stamp member 15 adjacent to the inner wall surface 40. As further shown therein, each stamp member 15 can be provided with a roller 90 to slide along the downward slope 16 of the lower housing 10b when the stamp member 15 is lowered into the extracted position.

As shown in FIG. 1 and 6, an operation unit 92 is provided to visually identify the operation status of the stamps. The operation unit 92 is formed on the top portion of the upper housing portion 10a together with a main LCD panel 93 and a sub LCD panel 95. A plurality of operation buttons 97 are aligned below the sub LCD panel 95. On the main LCD panel 93 is displayed the time taken for stamping, price total in case of pricing stamps, or score total in case of score recording stamps. The sub LCD panel 95 may be used for counting frequency of stamping of a particular stamp member 15.

Meanwhile, the operation buttons 97 may include an on/off button function and a reset button function to initialize frequency, elapsed time, price total, or score total. A mode selection button function may serve to select a display mode among elapsed time, price total or score total, for the main LCD panel 93. A storage button function may be also provided for storing information such as frequency, price total, or score total. Also, a number control button function may be provided to add up scores or prices according to the number of times a particular stamp member has been utilized for stamping. Such an operation is controlled by an operation circuit unit containing a processor and memory unit implemented in a printed circuit board 99 disposed within the upper housing 10a. Furthermore, a connection unit connects each stamp member to the operation circuit.

In order to facilitate the lifting operation of the lift rods 24, in an alternative embodiment (not shown) instead of handle portions 25 being formed on the lift rods 24, a plurality of push buttons (not shown) may be correspondingly attached to respective upper portions of the lift rods 24 so that each lift rod 24 can be lowered or lifted by the push of each push button. Also, the housing may be formed to make a 360 degree rotation and push buttons provided on top portion of the upper housing portion so that each push button can be placed on top of each lift rod 24 in accordance with the rotation of the housing 10, whereby each lift rod 22 is lowered or lifted back when a push button is selected and pushed.

In yet another embodiment shown in FIGS. 9 and 10, at least one stamp member is a multiple stamp member 100 provided within the housing 10. The multiple stamp member comprises an elongated case 102 having a wheel 105 rotatably mounted on each end thereof A belt 107 is wound in a single loop over the wheels 105 in a conveyor belt manner, and a plurality of print pads 110 are attached to the belt 107. A handle portion 109 extends from said elongated case 102, and the handle portion 109 extends outside the housing 10 through one of the plurality of vertically elongate openings17. The print pads 110 of the multiple stamp member 100 have different predetermined images embossed or imprinted thereon, and the belt 107 can be rotated manually so that the desired print pad 110 can be selected for stamping. Only one print pad 110 is exposed at the bottom end 112 of the case 102. Thus, the belt 107 is rotated until the desired print pad 110 is selected at the bottom end 112 for stamping.

In another embodiment (not shown), the stamping device further comprises a pen member placed within the housing. The pen member has an ink cartridge, lift rod with a handle portion, first and second protrusions on the lift rod, and is supported by the fixed plate with a spring between the second protrusion and fixed plate. The movement of the pen member operates in the same manner as the stamp member. The only difference is that instead of the print pad for stamping, the pen member has a felt or ball point tip of a pen beneath the ink cartridge for releasing ink received from the ink cartridge.

As discussed above, the multi-functional stamping device according to the present invention stores a plurality of stamps in the housing thereof and overcomes the conventional inconvenience in which various stamps are respectively stored and troublesome to find. Further, since the selected stamp is pushed out of the housing and returned into the housing when not used, the print pad can be efficiently prevented from drying and being contaminated by dirt or other alienate materials.

The uses for the device of the present invention may vary from office use for signature and other purposes, retail use for as pricing stamps, and in sports such as golf as scoring stamps to record scores. In addition, the multi-functional stamping device according to the present invention is provided with the operation unit for visualization of the stamping frequency of a particular stamp or price total in case of a pricing stamp, thereby maximizing the user's convenience. Also, when applied to a sport game such as golf, the multi-functional stamping device is easily adjusted to count and record scores in an advanced management. Moreover, the multi-functional stamping device enables a user to customize the stamp pads for his or her own convenience, thereby improving product reliability.

Although the invention has been described in considerable detail with reference to certain preferred versions thereof, other versions are possible by converting the aforementioned construction. Therefore, the scope of the invention shall not be limited by the specification specified above and the appended claims.

What is claimed is:

1. A multi-functional stamping device, comprising:
a housing having a stamp outcome port;
a plurality of stamp members provided in said housing;
each stamp member having a predetermined image for imprinting said inked image onto an external object thereon
each stamp member having a handle portion protruding outside said housing; and,
whereby each handle portion can be moved to control the movement of a corresponding stamp member between a retracted position wherein said stamp member is disposed within said housing and an extracted position wherein said stamp member protrudes outside said stamp outcome port of said housing.

2. The stamping device as described in claim 1 wherein said housing is elongated and said housing further comprises:
an upper housing portion, said upper housing portion having vertically elongate openings formed thereon to receive therethrough said handle portion of a corresponding stamp member; and,
a lower housing portion having said stamp outcome port disposed at a lower portion thereof.

3. The multi-functional stamping device as described in claim 1 further comprising a cover system for covering and opening said stamp outcome port.

4. The stamping device as described in claim 3 wherein said cover system comprises one or more lids hingeably attached to an inner wall surface of the stamp outcome port;
said one or more lids formed to cover said stamp outcome port when placed in a closed position;
each lid having a coiled return spring hingeably connecting said lid to said inner wall surface of said stamp outcome port to bias said lid towards said closed position;
whereby when a selected stamp member is lowered, said stamp member urges said one or more lids away from said stamp outcome port as said stamp member moves through said stamp outcome port to the extracted position; and,
whereby when a stamp member moves from an extracted position to said retracted position, the movement of said stamp member into said housing allows said one or more lids to return to said closed position.

5. The stamping device as described in claim 3 wherein said cover system comprises:
a push button switch protruding from said inner wall adjacent and above said stamp outcome port, said switch biased to protrude from said inner wall;
a door slideably mounted adjacent said stamp outcome port of said housing, said door sliding to cover and uncover said stamp outcome port;
a gear assembly contained within said inner wall adjacent said stamp outcome port, said gear assembly having a first gear member engaging said switch and a second gear connecting to a pin, said pin connecting to said door;
whereby when a selected stamp member is lowered, said stamp member pushes said switch into said inner wall urging said gear assembly to slide said door away from said stamp outcome port allowing said stamp member to exit through said uncovered stamp outcome port to the extracted position; and,
whereby when a stamp member moves from an extracted position to said retracted position, the movement of said stamp member into said housing allows switch member to protrude from said inner wall and thus allowing said gear assembly to return said door to a position covering said stamp outcome port.

6. The stamping device as described in claim 1 wherein each stamp member comprises:
a stamp cartridge containing therein ink absorbents, said cartridge attaching to an elongated lift rod; and,
a print pad attached to a lower portion of the stamp cartridge, said pad continuously receiving ink from said ink absorbents, said print pad having a predetermined image formed thereon.

7. The stamping device as described in claim 6 further comprising a roller engaged to the stamp cartridge adjacent to a side p5rtion of the print pad.

8. The stamping device as described in claim 6 further comprising:
a fixed plate affixed within said housing and supporting each lift rod of a stamp member;
a protrusion formed towards said upper end of each lift rod;
a spring disposed around each lift rod between said protrusion and fixed plate; and, each spring biased to urge each corresponding stamp member towards said retracted position.

9. The stamping device of claim 1 wherein one of the plurality of stamp members is an ink removing stamp member to absorb and remove the ink printed on a stamping target.

10. The stamping device as described in claim 1 wherein one of the plurality of stamp members is a pen member having an elongated ink filled rod member and attaching to a pen handle member, said housing having an elongated opening formed thereon to receive therethrough said pen handle member, said pen member further having an ink dispersing tip receiving ink from said rod member.

11. The stamping device of claim 1 where the housing includes an operation unit to display an operation status of the stamp.

12. A multi-functional stamping device, comprising:
an elongated housing having an upper housing portion and a lower housing portion, said upper housing portion having a predetermined number of vertically elongate openings formed thereon, said lower housing portion having a stamp outcome port disposed at a lower portion thereof;
a plurality of stamp members provided in said housing;
each stamp member comprising a stamp cartridge attaching to an elongated lift rod, said stamp cartridge containing therein ink absorbents, said stamp cartridge having a print pad attached to a lower portion thereof, said pad continuously receiving ink from said ink absorbents;
each print pad having a predetermined image for imprinting said inked image onto an external object thereon;
each lift rod having a handle portion protruding outside said housing through one of said corresponding vertically elongated openings;
whereby each handle portion can be moved to control the movement of a corresponding stamp member between a retracted position wherein said stamp member is disposed within said housing and an extracted position wherein said stamp member protrudes outside said stamp outcome port of said housing; and,
a cover system for covering and opening said stamp outcome port.

13. The stamping device as described in claim 12 wherein said cover system comprises one or more lids hingeably attached to an inner wall surface of the stamp outcome port;
said one or more lids formed to cover said stamp outcome port when placed in a closed position;
each lid having a coiled return spring hingeably connecting said lid to said inner wall surface of said stamp outcome port to bias said lid towards said closed position;
whereby when a selected stamp member is lowered, said stamp member urges said one or more lids away from said stamp outcome port as said stamp member moves through said stamp outcome port to the extracted position; and,
whereby when a stamp member moves from an extracted position to said retracted position, the movement of said stamp member into said housing allows said one or more lids to return to said closed position.

14. The stamping device as described in claim 12 wherein said cover system comprises:
a push button switch protruding from said inner wall adjacent and above said stamp outcome port, said switch biased to protrude from said inner wall;
a door slideably mounted adjacent said stamp outcome port of said housing, said door sliding to cover and uncover said stamp outcome port;
a gear assembly contained within said inner wall adjacent said stamp outcome port, said gear assembly having a first gear member engaging said switch and a second gear connecting to a pin, said pin connecting to said door;
whereby when a selected stamp member is lowered, said stamp member pushes said switch into said inner wall urging said gear assembly to slide said door away from said stamp outcome port allowing said stamp member to exit through said uncovered stamp outcome port to the extracted position; and,
whereby when a stamp member moves from an extracted position to said retracted position, the movement of said stamp member into said housing allows switch member to protrude from said inner wall and thus allowing said gear assembly to return said door to a position covering said stamp outcome port.

15. The stamping device as described in claim 12 further comprising a roller engaged to the stamp cartridge adjacent to a side portion of the print pad.

16. The stamping device as described in claim 12 further comprising:
a fixed plate affixed within said housing and supporting each lift rod of a stamp member;
a protrusion formed towards said upper end of each lift rod;
a spring disposed around each lift rod between said protrusion and fixed plate; and,
each spring biased to urge each corresponding stamp member towards said retracted position.

17. The stamping device of claim 12 wherein one of the plurality of print pads is an ink removing stamp pad for absorbing and removing the ink printed on a stamping target.

18. The stamping device of claim 12 where the housing includes an operation unit to display an operation status of the stamp.

19. A multi-functional stamping device, comprising:
an elongated housing having an upper housing portion and a lower housing portion, said upper housing portion having a predetermined number of vertically elongate openings formed thereon, said lower housing portion having a stamp outcome port disposed at a lower portion thereof,
a plurality of primary stamp members provided in said housing;
each stamp member comprising a stamp cartridge attaching to an elongated lift rod, said stamp cartridge containing therein ink absorbents, said stamp cartridge having a print pad attached to a lower portion thereof, said pad continuously receiving ink from said ink absorbents;
each print pad having a predetermined image for imprinting said inked image onto an external object thereon;
each lift rod having a handle portion protruding outside said housing through one of said corresponding vertically elongated openings;
at least one multiple stamp member provided within said housing, said multiple stamp member comprising:
an elongated case having a wheel rotatably mounted on each end thereof;
a belt disposed over said wheels to form a loop;
a plurality of print pads disposed on said belt;
a handle portion extending from said elongated rod;
whereby each handle portion can be moved to control the movement of a corresponding stamp member between a retracted position wherein said stamp member is disposed within said housing and an extracted position wherein said stamp member protrudes outside said stamp outcome port of said housing; and,
a cover system for covering and opening said stamp outcome port.

20. The stamping device as described in claim 19 wherein said cover system comprises one or more lids hingeably attached to an inner wall surface of the stamp outcome port;
said one or more lids formed to cover said stamp outcome port when placed in a closed position;
each lid having a coiled return spring hingeably connecting said lid to said inner wall surface of said stamp outcome port to bias said lid towards said closed position;
whereby when a selected stamp member is lowered, said stamp member urges said one or more lids away from said stamp outcome port as said stamp member moves through said stamp outcome port to the extracted position; and,
whereby when a stamp member moves from an extracted position to said retracted position, the movement of said stamp member into said housing allows said one or more lids to return to said closed position.

21. The stamping device as described in claim 19 wherein said cover system comprises:
a push button switch protruding from said inner wall adjacent and above said stamp outcome port, said switch biased to protrude from said inner wall;
a door slideably mounted adjacent said stamp outcome port of said housing, said door sliding to cover and uncover said stamp outcome port;
a gear assembly contained within said inner wall adjacent said stamp outcome port, said gear assembly having a first gear member engaging said switch and a second gear connecting to a pin, said pin connecting to said door;
whereby when a selected stamp member is lowered, said stamp member pushes said switch into said inner wall urging said gear assembly to slide said door away from said stamp outcome port allowing said stamp member to exit through said uncovered stamp outcome port to the extracted position; and,
whereby when a stamp member moves from an extracted position to said retracted position, the movement of said stamp member into said housing allows switch member to protrude from said inner wall and thus allowing said gear assembly to return said door to a position covering said stamp outcome port.

22. The stamping device as described in claim 19 further comprising a roller engaged to the stamp cartridge adjacent to a side portion of the print pad.

23. The stamping device as described in claim 19 further comprising:
a fixed plate affixed within said housing and supporting each lift rod of a stamp member;
a protrusion formed towards said upper end of each lift rod;
a spring disposed around each lift rod between said protrusion and fixed plate; and,
each spring biased to urge each corresponding stamp member towards said retracted position.

24. The stamping device of claim 19 wherein one of said plurality of stamp members has a print pad having an ink removing stamp to absorb and remove the ink printed on a stamping target.

25. The stamping device of claim 19 where the housing includes an operation unit to display an operation status of the stamp.
